(19) United States
(12) Patent Application Publication
(10) Pub. No.: US 2018/0358011 A1
(43) Pub. Date: Dec. 13, 2018

(54) PROVIDING EVENT BASED ACTIVITY SERVICE FOR CONVERSATIONAL ENVIRONMENT

(71) Applicant: MICROSOFT TECHNOLOGY LICENSING, LLC, Redmond, WA (US)

(72) Inventors: Michael Thomas MCLEAN, Snoqualmie, WA (US); Kiran P. KAJA, Sammamish, WA (US); Rafael Ferreira BARCELOS, Kirkland, WA (US); lzis DE MELO MOREIRA, Kirkland, WA (US)

(73) Assignee: MICROSOFT TECHNOLOGY LICENSING, LLC, Redmond, WA (US)

(21) Appl. No.: 15/620,872

(22) Filed: Jun. 13, 2017

(51) Int. Cl. G10L 15/22; H04L 12/58; G06Q 10/10; H04M 3/56; G06F 17/27; G10L 15/18

(52) U.S. Cl. CPC G10L 15/22; H04L 51/16; G06Q 10/1095; G10L 2015/223; G06F 17/2785; G10L 15/1815; H04M 3/565

(57) ABSTRACT

Variety of approaches to provide an event based activity service are described. A communication service initiates operations) to provide the event based activity service upon analyzing at least a portion of a conversation. An activity associated with the conversation is inferred froth the analyzed portion. Next, an item associated with the activity is created. A creation notification associated with the item is inserted into the conversation.

### BACKGROUND

Information exchange have changed processes associated work and personal environments. Automation and improvements in processes have expanded scope of capabilities offered for personal and business data consumption. With the development of faster and smaller electronics, execution of mass processes at cloud systems have become feasible. Indeed, applications provided by data centers, data warehouses, data workstations have become common features in modem personal and work environments. Communication service(s) provide a wide variety of applications ranging from hosting, management facilitating collaboration, among others associated with conversation(s).

Increasingly, cloud based resources are utilized for variety of services that include communication services, among others that facilitate hosting, management, and/or collaboration, among other operations associated with assets such as conversations. However, there are currently substantial gaps in dynamically providing based activity service(s). Personnel resources are unnecessarily consumed for analyzing, detecting, and/or processing activity(s) in conversation(s). Lack of relevant management solutions to dynamically provide event based activity service(s) cause poor management of personnel resources and time when attempting to recognize and/or interact with activity(s) in conversation(s).

### SUMMARY

This summary is provided to introduce a selection of concepts in a simplified form that are further described below in the Detailed Description. This summary is not intended to exclusively identify key features of essential features of the claimed subject matter, nor is it intended as an aid in determining the scope of the claimed subject matter.

Embodiments are directed to an event based activity service for a conversational environment. A communication service, according to embodiments, may initiate operations to provide an event based activity service by analyzing at least a portion of a conversation. An activity associated with the conversation may be inferred from the analyzed portion. Next, an item associated with the activity may be created. A creation notification associated with the item may be inserted into the conversation.

These and other features and advantages will be apparent from a reading of the following detailed description and a review of the associated drawings. It is to be understood that both the foregoing general description and the following detailed description are explanatory and do not restrict aspects as claimed.

### BRIEF DESCRIPTION OF THE DRAWINGS

FIG. 1 is a conceptual diagram illustrating examples of providing an event based activity service for a conversational environment, according to embodiments;

FIG. 2 is a display diagram illustrating example components of a communication service that provides an event based activity service for a conversational environment, according to embodiments;

FIG. 3 is a display diagram illustrating components of a scheme to provide an event based activity service for a conversational environment, according to embodiments;

FIG. 4 is a display diagram illustrating another example of a scheme to provide an event based activity service for a conversational environment, according to embodiments;

FIG. 5 is a display diagram illustrating an additional example of a scheme to provide an event based activity service for a conversational environment, according to embodiments;

FIG. 6 is a simplified networked environment, where a system according to embodiments may be implemented;

FIG. 7 is a block diagram of an example computing device, which may be used to provide an event based activity service for a conversational environment, according to embodiments; and

FIG. 8 is a logic flow diagram illustrating a process for providing an event based activity service for a conversational environment, according to embodiments.

### DETAILED DESCRIPTION

As briefly described above, a communication service may provide an event based activity service for a conversational environment. In an example scenario, the communication service may analyze at least a portion of a conversation. The conversation may include a combination of text based messages, emails, voice based messages, visual messages, and/or a recording of a conference, among others. The conversation may include an active conversation, an inactive conversation, a saved conversation, and/or a new conversation, among others. The portion of the conversation may be analyzed based on a text based analysis, a voice based analysis, a gesture based analysis, and/or a visual based analysis, among others.

An activity associated with the conversation may be inferred from the analyzed portion. The activity may include a description of a task, an appointment, a call, a meeting, and/or a conference call, among others. The activity may be parsed to detect attributes of the activity such as an identifier, a time period, and/or a location, among other things. The attributes may be formatted with delimiters. The delimiters may vary based on a type of the attribute. Next, an item associated with the activity may be created. The item may include a task, an appointment, a call, a meeting, and/or a conference call, among others. A creation notification associated with the item may be inserted into the conversation.

Alternatively, a participant of the conversation may be prompted to confirm the activity. The activity may be transmitted to a client application associated with the participant. The client application may be instructed to interact with the participant to generate a confirmation of the activity. The communication service may create the item associated with the activity upon receiving the confirmation.

In the following detailed description, references are made to the accompanying drawings that form a part hereof, and in which are shown by way of illustrations, specific embodiments, or examples. These aspects may be combined, other aspects may be utilized, and structural changes may be made without departing from the spirit or scope of the present disclosure. The following detailed description is therefore not to be taken in a limiting sense, and the scope of the present invention is defined by the appended claims and their equivalents.

While some embodiments will be described in the general context of program modules that execute in conjunction with an application program that runs on an operating system on a personal computer, those skilled in the art will recognize that aspects may also be implemented in combination with other program modules.

Generally, program modules include routines, programs, components, data structures, and other types of structures that perform particular tasks or implement particular abstract data types. Moreover, those skilled in the art will appreciate that embodiments may be practiced with other computer system configurations, including hand-held devices, multiprocessor systems, microprocessor-based or programmable consumer electronics, minicomputers, mainframe computers, and comparable computing devices. Embodiments may also be practiced in distributed computing environments where tasks are performed by remote processing devices that are linked through a communications network. In a distributed computing environment, program modules may be located in both local and remote memory storage devices.

Some embodiments may be implemented as a computer-implemented process (method), a computing system, or as an article of manufacture, such as a computer program product or computer readable media. The computer program product may be a computer storage medium readable by a computer system and encoding a computer program that comprises instructions for causing a computer or computing system to perform example process(es). The computer-readable storage medium is a computer-readable memory device. The computer-readable storage medium can for example be implemented via one or more of a volatile computer memory, a non-volatile memory, a hard drive, a hash drive, a floppy disk, or a compact disk, and comparable hardware media.

Throughout this specification, the term “platform” may be a combination of software and hardware components for providing an event based activity service for a conversational platform. Examples of platforms include, but are not limited to, a hosted service executed over a plurality of servers, an application executed on a single computing device, and comparable systems. The term “server” generally refers to a computing device executing one or more software programs typically in a networked environment. However, a server may also be implemented as a virtual server (software programs) executed on one or more computing devices viewed as a server on the network. More detail on these technologies and example operations is provided below.

A computing device, as used herein, refers to a device comprising at least a memory and a processor that includes a desktop computer, a laptop computer, a tablet computer, a smart phone, a vehicle mount computer, or a wearable computer. A memory may be a removable or non-removable component of a computing device configured to store one or more instructions to be executed by one or more processors. A processor may be a component of a computing device coupled to a memory and configured to execute programs in conjunction with instructions stored by the memory. A file is any form of structured data that is associated with audio, video, or similar content. An operating system is a system configured to manage hardware and software components of a computing device that provides common services and applications. An integrated module is a component of an application or service that is integrated within the application or service such that the application or service is configured to execute the component. A computer-readable memory device is a physical computer-readable storage medium implemented via one or more of a volatile computer memory, a non-volatile memory, a hard drive, a flash drive, a floppy disk, or a compact disk, and comparable hardware media that includes instructions thereon to automatically save content to a location. A user experience—a visual display associated with an application or service through which a user interacts with the application or service. A user action refers to an interaction between a user and a user experience of an application or a user experience provided by a service that includes one of touch input, gesture input, voice command, eye tracking, gyroscopic input, pen input, mouse input, and keyboards input. An application programming interface (API) may be a set of routines, protocols, and tools for an application or service that enable the application or service to interact or communicate with one or more other applications and services managed by separate entities.

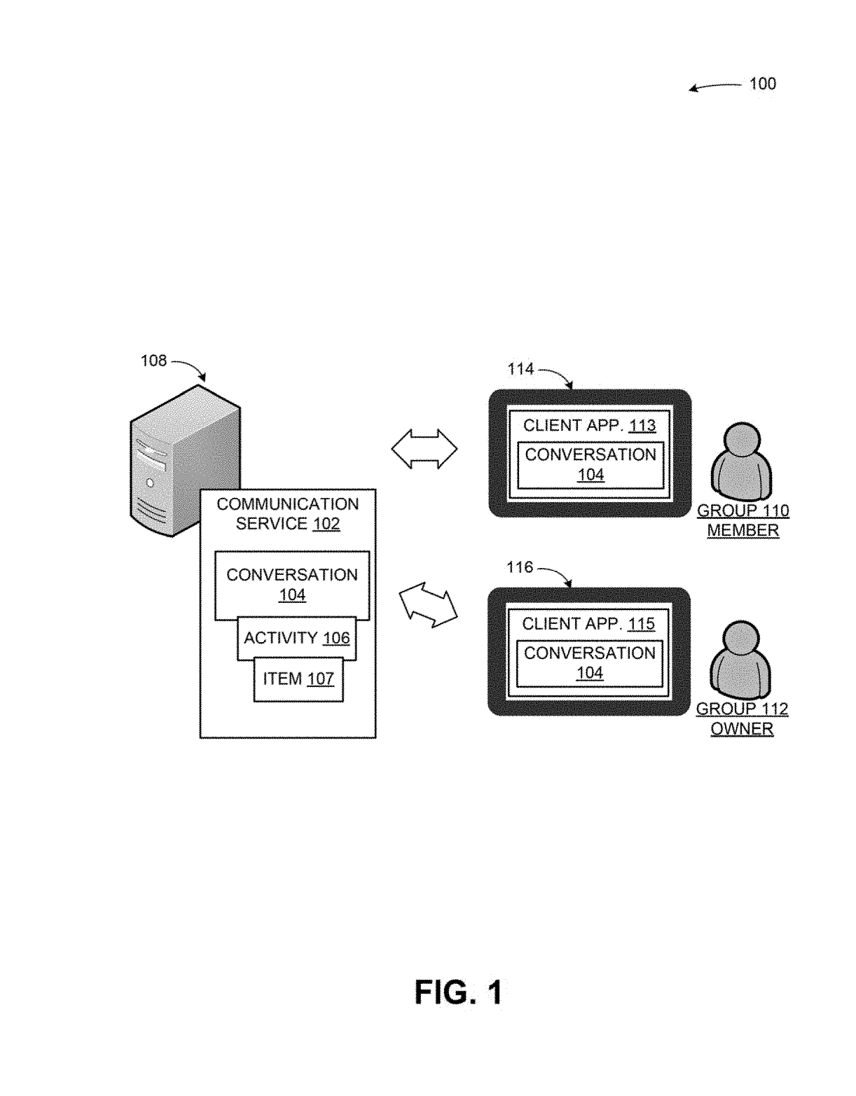

FIG. 1 is a conceptual diagram illustrating examples of providing an event based activity service for a conversational environment, according to embodiments.

In a diagram 100, a server 108 may execute (or provide) a communication service 102. The server 108 may include a physical server providing service(s), application(s), and/or an interface to client devices. A service (such as the communication service 102) may include an application performing operations in relation to a client application and/or a subscriber, among others. The server 108 may include and/or is part of a workstation, a data warehouse, a data center, and/or a cloud based distributed computing source, among others.

The server 108 may execute the communication service 102. The communication service 102 may analyze at least a portion of a conversation 104. The conversation may include a combination of text based messages, emails, voice based messages, visual messages, and or a recording of a conference among others. The conversation 104 may include an active conversation, an inactive conversation, a saved conversation, and/or a new conversation, among others. The portion of the conversation 104 may be analyzed based on a text based analysis, a voice based analysis, a gesture based analysis, and/or a visual based analysis, among others. Furthermore, a purpose of the conversation 104 may include facilitating a collaboration between a group.

An activity 106 associated with the conversation 104 may be inferred from the analyzed portion. The activity 106 may include a description of a task, an appointment, a call, a meeting, and/or a conference call, among others. The activity 106 may be parsed to detect attributes of the activity 106 such as an identifier (of an owner), a title, a subject, a description (such as a summary), a time period, and/or a location, a long other things. The attributes may be formatted with delimiters. The delimiters may vary based on a type of the attribute.

Next, an item 107 associated with the activity 106 may be created. The activity 106 may be a description for the item 107 which may be used to generate the item 107. The item 107 may include a task, an appointment, a call, a meeting, and/or a conference call, among others. A creation notification associated with the item 107 may be inserted into the conversation 104. The creation notification may include a summary, a description, and/or link to the item 107 among other descriptive information associated with the item 107.

Alternatively, a participant of the conversation 104 may be prompted to confirm the activity. The participant may include a group member 110 (of the group) and a group owner 112 (of the group). The activity 106 may also be transmitted to a client application (such as the client applications (113 and 115) provided by client devices (114 and 116), respectively) associated with the participant (such as the group member 110 and the group owner 112). The client application may be instructed to interact with the participant to generate a confirmation of the activity 106. The communication service 102 may create the item 107 upon receiving the confirmation.

The server 108 may communicate with the client device 114, and/or the client device 116, through a network. The network may provide wired or wireless communications between network nodes such as the client device 114, the client device 116, and/or the server 108, among others. Previous example(s) to provide an event based activity service for a conversational environment are not provided in a limiting sense. Alternatively, the communication service 102 may determine the activity 106 and provide the item 107 as a desktop application, a workstation application, and/or a server application, among others. The client application 113 and the client application 115 may also include a client interface interacting with the communication service 102.

The group member 110 and/or the group owner 112 may interact with the client application 113 and/or the client application 115, respectively, with a keyboard based input, a mouse based input, a voice based input, a pen based input, and a gesture based input, among others. The gesture based input may include one or more touch based actions such as a touch action, a swipe action, and a combination of each, among others.

While the example system in FIG. 1 has been described with specific components including the server 108, the communication service 102, embodiments are not limited to these components or system configurations and can be implemented with other system configuration employing fewer or additional components.

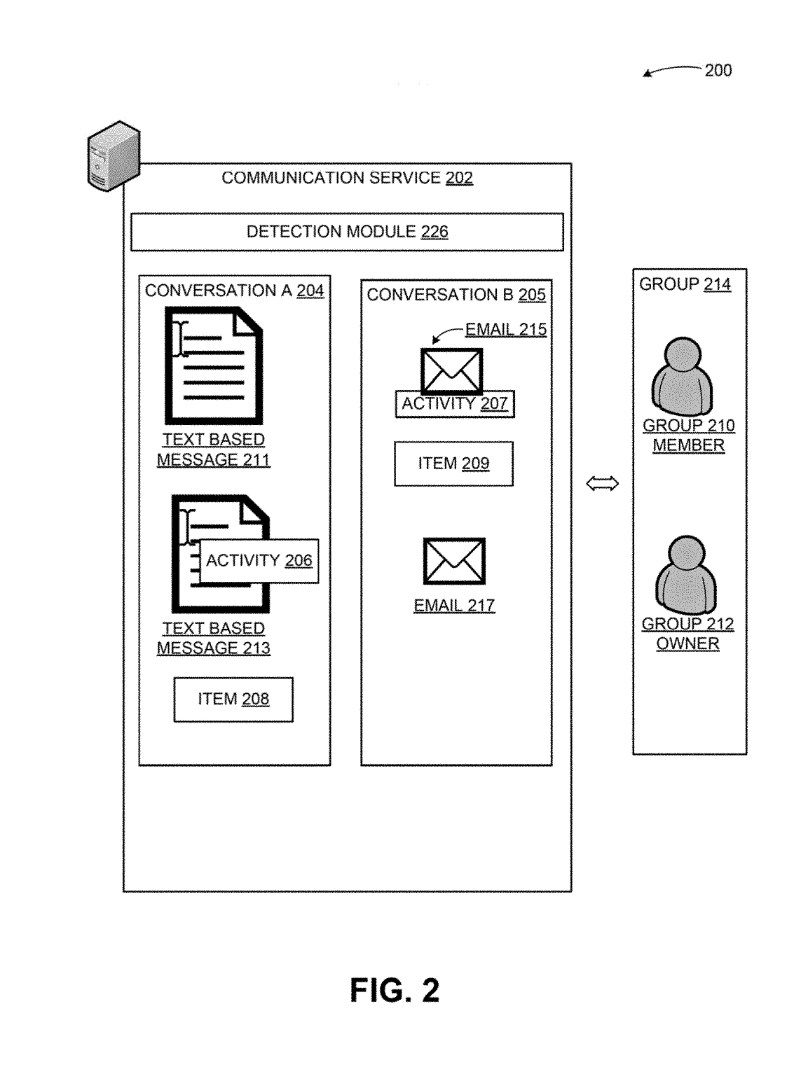

FIG. 2 is a display diagram illustrating example components of a communication service that provides an event based activity service for a conversational environment, according to embodiments.

As illustrated in diagram 200, a detection module 226 of a communication service 202 may analyze a conversation A 204 and/or a conversation B 205. The conversation A 204 and/or the conversation B 205 may include a combination of text, email, audio, and/or video based messages. Members of a group 214 may communicate and collaborate with each other through the conversation A 204 and/or the conversation B 205. The group 214 may include a group member 210 and a group owner 212. The group member 210 may be authorized to participate in the conversation A 204 and/or the conversation B 205. The group owner 212 may be authorized to create, edit, and/or delete the conversation A 204 and/or the conversation A 205. The group owner 212 may also be authorized to add and/or delete members to/from the group 214.

In an example scenario, the detection module 226 may analyze a conversation A 204 to identify an activity 206. The conversation A 204 may be processed to detect portion(s) such as a text based message 211 provided by the group member 210 and a text based message 213 provided by the group owner 212. Some or all portion(s) of the conversation A 204 such as the text based message 213 may be analyzed to identify activity(s) associated with the conversation A 204. The text based message 211 may be detected as describing an activity 206. The activity 206 may include a description of a task, an appointment, a meeting, a call, and/or a conference call, among others. For example, the text based message 213 may include a description of a task with art identifier of a stakeholder (a person, a group member, and/or an external entity, among others), a title, a subject, a description (such as a summary), a time period, and/or other attribute(s) associated with the task. Next, an item 208 (such as the task) may be generated based on the description (also known as the activity 206). The item 208 may be hosted and/or managed by the communication service 202 or provided to other service(s) (such as a scheduling service) for hosting and/or management.

Alternatively, the detection module 226 may prompt the group owner 212 (or other authorized stakeholder) to confirm the activity 206. The description may be used to generate the item 208 (such as the task) upon receiving a confirmation from the group owner 212 (or other authorized stakeholder).

In another example scenario, the detection module 226 may process an email 215 provided by the group member 210 and an email 217 provided by the group owner 212 as portion(s) of the conversation B 205. An activity 207 may be detected upon an analysis of the email 215. For example, the activity 207 may describe a meeting that may include invitee(s), a time period, and/or a location. Next, an item 209 (such as the meeting) associated with the activity 207 may be created. The item 209 may be hosted and/or managed locally and/or transmitted to other service (such as a scheduling service) for hosting and/or management. Alternatively, the group member 210 may be prompted to confirm the activity 207 detected within the email 215. The item 209 (such as the meeting) may be created upon receiving a confirmation.

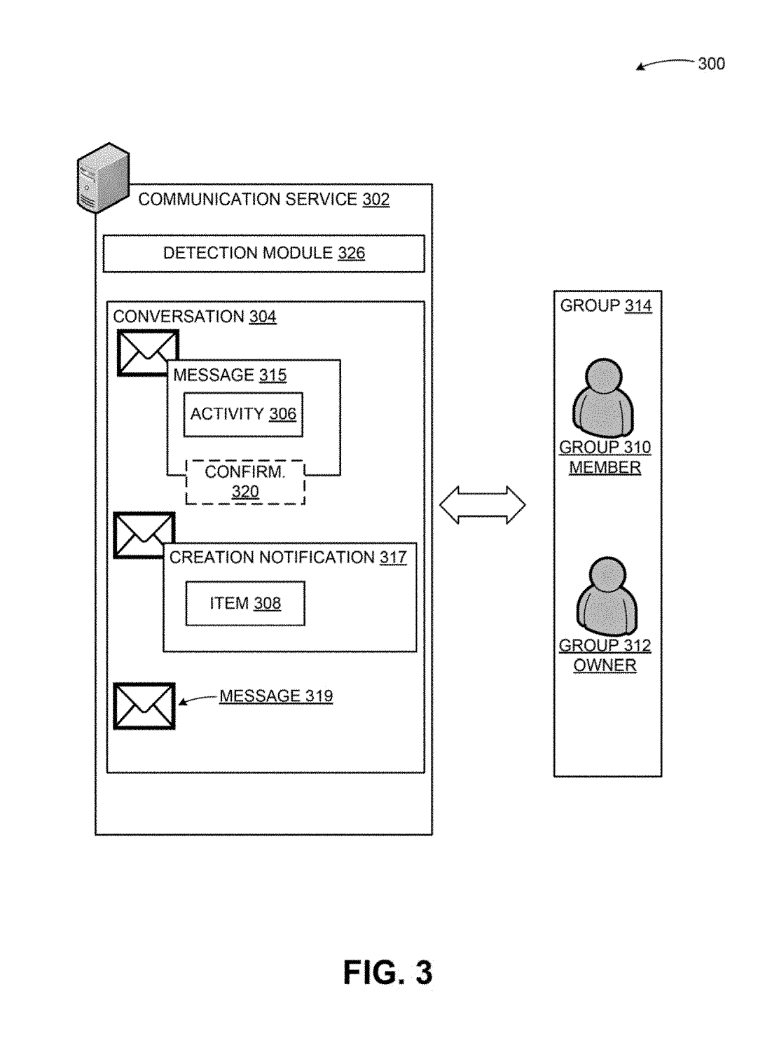

FIG. 3 is a display diagram illustrating components of a scheme to provide an event based activity service for a conversational environment, according to embodiments.

As shown in a diagram 300, a detection module 326 of a communication service 302 may analyze a conversation 304 for an activity 306. In an example scenario, the detection module 326 may host and/or manage the conversation 304 for a group 314. The group 314 may include a group member 310 and a group owner 312. The group member 310 and the group owner 312 (among other group member(s)) may participate in the conversation 304 with a combination of message(s) that are sent, received, and/or replied. Furthermore, an external entity (such as a machine based intelligence and/or a person) may interact with the group through the conversation 304. The conversation 304 may include multiple messages such as a message 315 and/or a message 319, among others.

For example, the detection module 326 may analyze a portion of the conversation 304 such as a message 315 to identify a description of an activity 306. Machine learning scheme(s) may be used to recognize the activity 306. For example, a pattern recognition scheme may be used to analyze text based data within the message 315 to identify the activity 306. Voice based data may be converted to text for identification of the activity 306. Furthermore, gesture based data and/or visual data within the message 315 may be processed through recognition schemes to identify the activity 306. The description of the activity 306 may be recognized upon analysis by various recognition schemes.

The description may include multiple attributes associated with the activity such as an identifier of a stakeholder, a title, a subject, a description (such as a summary), a time period, and/or a location associated with the activity 306, among others. Next, the detection module 326 may create an item 30$ based on the activity 306. The item 308 may be configured based on the attributes associated with the activity 306. The item 308 may include a task, an appointment, a meeting, a call, and/or a conference, among others that may be described by the activity 306. The item may be hosted and/or managed and/or provided to other service for hosting and/or management.

Alternatively, the detection module 326 may prompt a participant who provided the message 315 (such as a group member 310, the group owner 312, or an external entity) to confirm the activity 306. A client application that renders the message 316 to the participant may be instructed to display a user experience (UX) element to confirm the activity 306. The client application may be instructed to place the UX element in proximity to the message 315. The client application may also be instructed to display a description of the activity within the UX element. Upon receiving a confirmation 320 from the participant, the item 308 may be created.

A creation notification 317 may be generated that includes a title, a subject, a description (such as a summary) of the item 308, and/or a link to the item 308. The creation notification 317 may be inserted into the conversation 304. The creation notification 317 may be placed immediately after the message 315 to highlight a relationship between the item and the message 315. Furthermore, the creation notification 317 may be formatted in a type that matches the message 315. For example, if the message 315 is formatted as an email, the creation notification 317 may be formatted as an email. The creation notification 317 may also be provided to client applications that display the conversation to the participant and other participant(s).

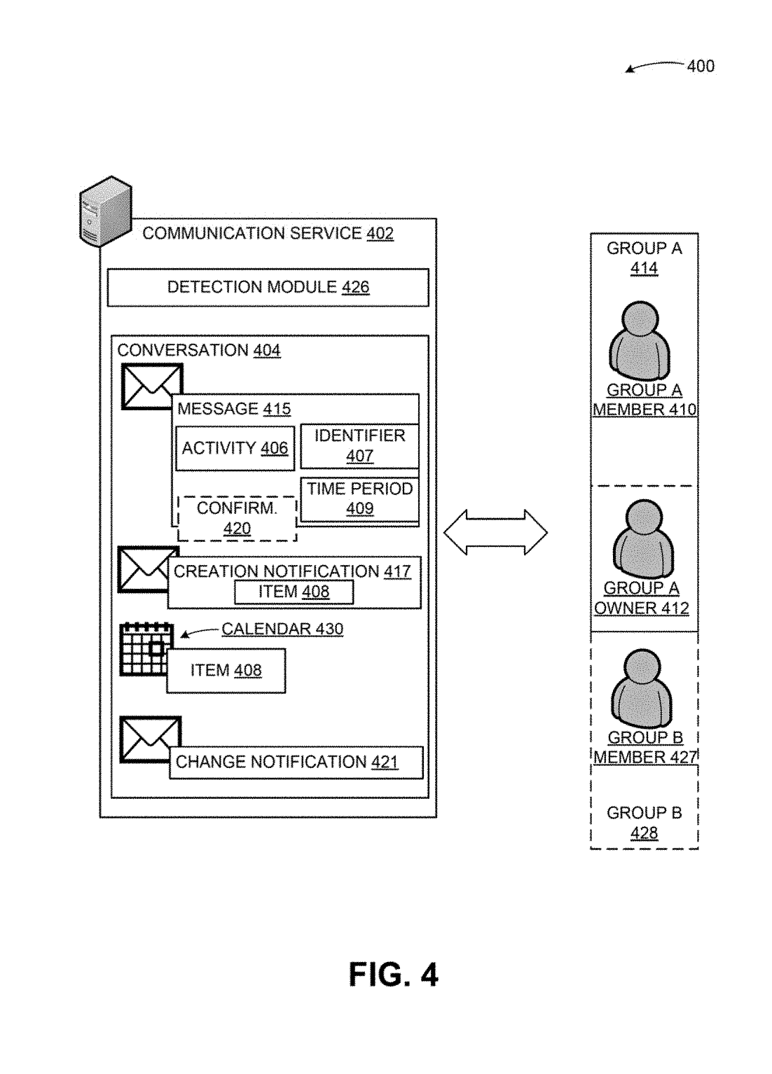

FIG. 4 is a display diagram illustrating another example of a scheme to provide an event based activity service for a conversational environment, according to embodiments.

As shown in a diagram 400, a detection module 426 of a communication service 402 may analyze a portion of a conversation 404 such as a message 415 to identify an activity 406 embedded within a content of the message 415. The activity may include a description of an item 408 such as a task, an appointment, a meeting, a call, and/or a conference, among other things. The item 408 may be automatically created based on the activity 406 by configuring the item 408 based on attribute(s) detected in the activity 406 such as an identifier (of an owner of the item 408), a title, a subject, a description (such as a summary), a time period 409, and/or a location associated with the item 408.

Alternatively, the detection module 426 may prompt a participant of the conversation 404 to confirm the activity 406. The participant may be a member of a group 414 that communicates and/or collaborates through the conversation 404. The participant may include a group A member 410 and/or a group A owner 412. A client application rendering the conversation 404 to the participant may be instructed to display the confirmation 420 in a location that is in proximity to the message 415 to emphasize a relationship between the message 415 and the activity 406. The item 408 may be created upon receiving the confirmation 420 from the participant.

A creation notification 417 may also be generated that includes a subject, a title, a description (such as a summary), and/or a link to the item 408. The creation notification 417 may be formatted based on a type of the message 415. The creation notification 417 may also be inserted into the conversation 404. As such, when the client application that renders the conversation 404 to the participant, displays the conversation 404, the participant may be informed about the item 408 that is created.

The detection module 426 may also host and/or manage the item 408 by inserting the item 408 into a service associated with the participant such as a scheduling service. For example, the item 408 may be inserted into a calendar 430 of the participant. Alternatively, if the service is provided by an external provider, then the item 408 may be transmitted to the external provider for hosting and/or management. Whether hosted and/or managed locally or externally, a status of the item 408 may be tracked by the detection module 426. If a change in the status is detected (such as a reminder, in progress, incomplete, and/or complete, among others), the change in the status may be inserted into the conversation in a change notification 421. The change notification 421 may be formatted in a type of the message 415 (such as a text based message, and/or email, among others). If the item 408 is hosted and/or managed by the external provider, the external provider may be queried regarding the change in the status of the item 408. Alternatively, the detection module 426 may subscribe to notification(s) about the change in a status of the item 408 from the external provider.

In another example scenario, the group A owner 412 may be detected as associated with a group B 428. In such as a scenario, the activity may be analyzed to detect a relationship between the activity and the group B 428 based on a context of the activity and/or a relationship between the group A owner 412 and/or the activity 406 and members of the group B 428 such as a group B member 427. if a relationship between the activity 406 and members of the group B 428 is detected then the item 408 may also be automatically assigned to a member of the group B 428. Alternatively, a member of the group B 428 such as the group B member 427 may be prompted to confirm the activity 406. Upon receiving the confirmation 420 from the group B member 427, the item 408 may be assigned to the group B member 427 (in addition to previous assignment(s) to other participant(s)).

In a further example scenario, attributes such as an identifier 407, a subject, a title, a description (such as a summary), and/or a time period 409 may be detected within the activity 406. The attributes may be formatted with delimiters and/or markers that identify the attributes as components of the activity 406. As such, the attributes may be used to identify the activity 406 from within a content of the message 415. For example, the identifier 407 may be preceded and/or followed by a marker (such as a special character). The marker may be recognized and an associated string and may be parsed as the identifier 407. Similarly, the time period 409 may be preceded and/or followed by other marker which may be recognized as an associated string and may be parsed as the time period 409.

The identifier 407 may also be used to assign an owner to the item 408. The identifier 407 may be recognized as associated with the participant such as the group A member 410, and/or the group A owner 412. Alternatively, the identifier 407 may be recognized as associated with an external entity such as the group B member 427 and/or an external provider. In such a scenario, an authorization of the external entity to inherit the item 408 may be confirmed (for example by querying a personnel data source that includes information associated with the external entity for one or more role(s) of the external entity). If confirmed, the item 408 may be assigned to the external entity.

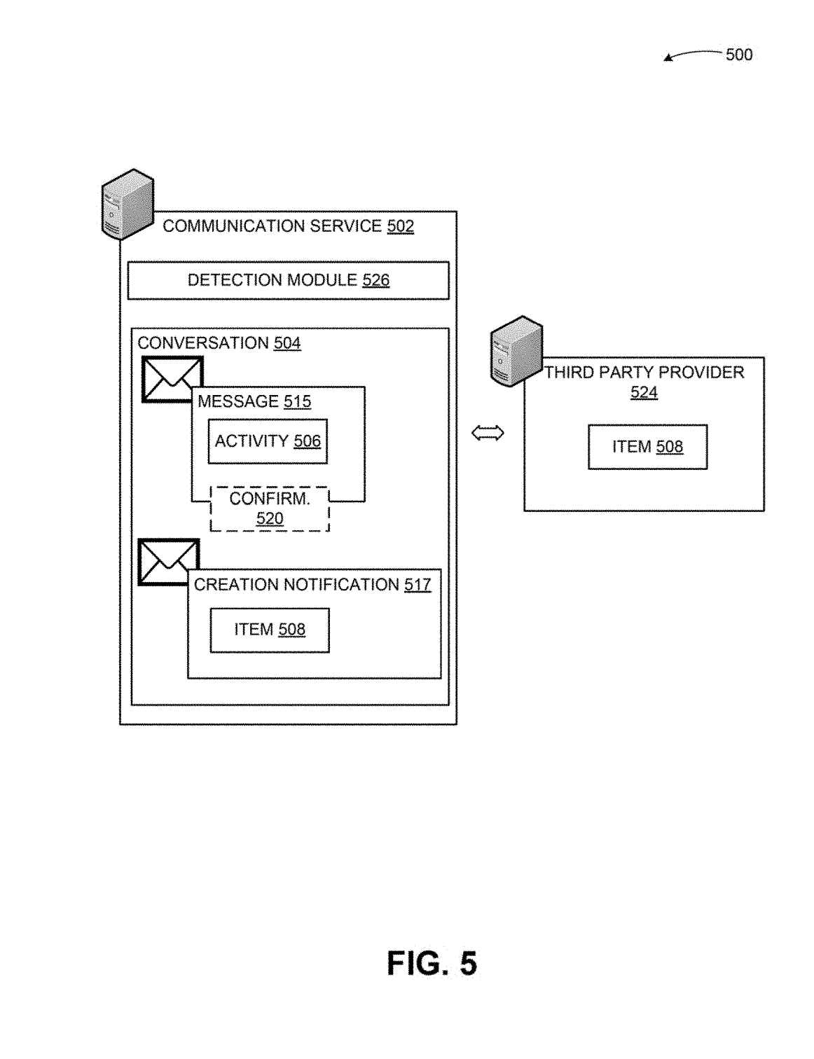

FIG. 5 is a display diagram illustrating an additional example of a scheme to provide an event based activity service for a conversational environment, according to embodiments.

As shown in a diagram 500, a detection module 526 of a communication service 502 may analyze a conversation 504 to identify a portion of the conversation such as a message 515 that includes an activity 506. Next, an item 508 may be created based on the activity 506. A creation notification 517 may also be inserted into the conversation 504 with a summary, a description, and/or a link to the item 508. Alternatively, a participant of the conversation that provided the message 515 may be prompted to confirm the activity 506. The item 508 may be created upon receiving a confirmation 520 from the participant.

In an example scenario, the activity may be analyzed to detect a relationship with a third party provider 524. For example, the item 508 (such as a task, an appointment, a meeting, a call, and/or a conference, among others) may be detected as intended for an assignment to the third party provider 524. In such a scenario, the item 508 may be transmitted to the third party provider 524 for hosting and/or management. Alternatively, the third party provider 524 may be sent a set of instructions to create the item 508 and manage and/or host the item 508. The third party provider 524 may also be instructed to provide status update(s) regarding the item 508 periodically or in response to a detected change in a status of the item 508.

The detection module 526 may also generate a duplicate of the item 508 in response to a request from an authorized stakeholder. The authorized stakeholder may include a participant of the conversation 504 and/or the third party provider 524. Upon receiving the request (and/or confirming art authorization of the requester to request the duplicate item), the detection module 526 may generate the duplicate item. The detection module 526 may also insert a notification into the conversation to inform participant(s) of the conversation regarding a creation of the duplicate item. If a third party requests the duplicate item, the notification may also be transmitted to the third party.

As discussed above, the communication service may be employed to perform operations to provide an event based activity service for a conversational environment. An increased performance and efficiency improvement with the communication service 102 may occur as a result of automatically analyzing a content of a conversation to identity an activity. Additionally, automated item and status notification(s) creation and/or management based operation(s) and process(es) executed by the communication service 102, and may reduce processor load, increase processing speed, conserve memory, and reduce network bandwidth usage.

Embodiments, as described herein, address a need that arises from a lack of efficiency to provide an event based activity service for a conversational environment. The actions/operations described herein are not a mere use of a computer, but address results that are a direct consequence of software used as a service offered to large numbers of users and applications.

The example scenarios and schemas in FIG. 1 through 5 are shown with specific components, data types, and configurations. Embodiments are not limited to systems according to these example configurations. Providing an event based activity service for a conversational environment may be implemented in configurations employing fewer or additional components in applications and user interfaces. Furthermore, the example schema and components shown in FIG. 1 through 5 and their subcomponents may be implemented in a similar manner with other values using the principles described herein.

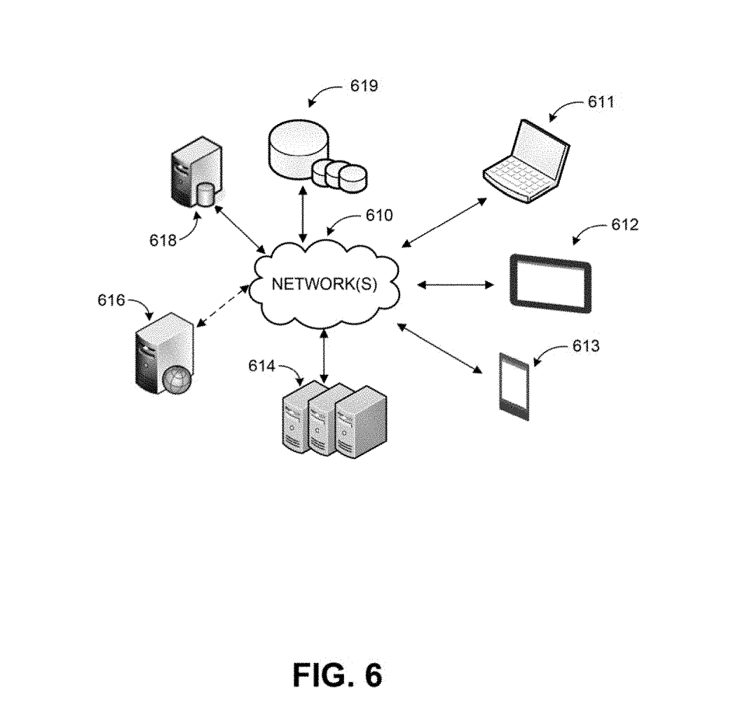

FIG. 6 is an example networked environment, where embodiments may be implemented. A communication service configured to provide an event based activity service for a conversational environment may be implemented via software executed over one or more servers 614 such as a hosted service. The platform may communicate with client applications on individual computing devices such as a smart phone 613, a mobile computer 612, or desktop computer 611 (‘client devices’) through network(s) 610.

Client applications executed on any of the client devices 611-613 may facilitate communications via application(s) executed by servers 614, or on individual server 616. A communication service may analyze at least a portion of a conversation. An activity associated with the conversation may be inferred from the analyzed portion. Next, an item associated with the activity may be created. A creation notification associated with the item may be inserted into the conversation. Alternatively, a participant of the conversation may be prompted to confirm the activity. The item may be created upon receiving a confirmation. The communication service may store data associated with the activity in data store(s) 619 directly or through database server 618.

Network(s) 610 may comprise any topology of servers, clients, Internet service providers, and communication media. A system according to embodiments may have a static or dynamic topology. Network(s) 610 may include secure networks such as an enterprise network, an unsecure network such as a wireless open network, or the Internet. Network(s) 610 may also coordinate communication over other networks such as Public Switched Telephone Network (PSTN) or cellular networks. Furthermore, network(s) 610 may include short range wireless networks such as Bluetooth or similar ones. Network(s) 610 provide communication between the nodes described herein. By way of example, and not limitation, network(s) 610 may include wireless media such as acoustic, RF, infrared and other wireless media.

Many other configurations of computing devices, applications, data sources, and data distribution systems may be employed to provide an event based activity service for a conversational environment. Furthermore, the networked environments discussed in FIG. 6 are for illustration purposes only. Embodiments are not limited to the example applications, modules, or processes.

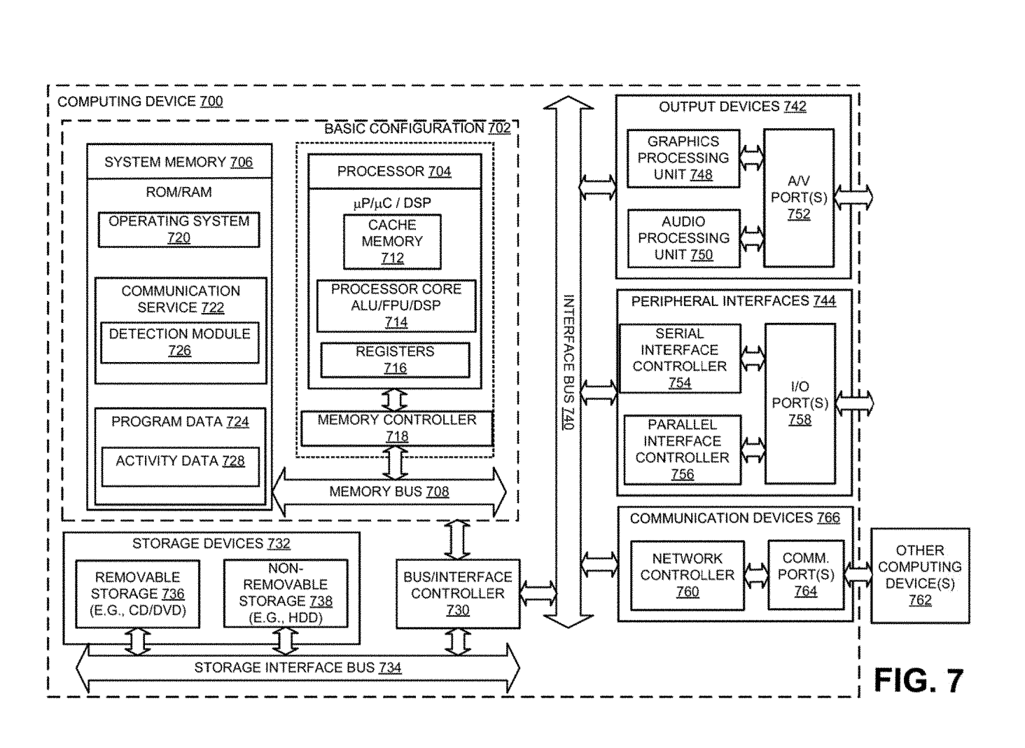

FIG. 7 is a block diagram of an example computing device, which may be used to provide an event based activity service for a conversational environment, according to embodiments.

For example, computing device 700 may be used as a server, desktop computer, portable computer, smart phone, special purpose computer, or similar device. In an example basic configuration 702, the computing device 700 may include one or more processors 704 and a system memory 706. A memory bus 708 may be used for communication between the processor 704 and the system memory 706. The basic configuration 702 may be illustrated in FIG. 7 by those components within the inner dashed line.

Depending on the desired configuration, the processor 704 may be of any type, including but not limited to a microprocessor (μP), a microcontroller (μC), a digital signal processor (DSP), or any combination thereof. The processor 704 may include one more levels of caching, such as a level cache memory 712, one or more processor cores 714, and registers 716. The example processor cores 714 may (each) include an arithmetic logic unit (ALU), a floating point unit (FPU), a digital signal processing core (DSP Core), a graphics processing unit (GPU), or any combination thereof. An example memory controller 718 may also be used with the processor 704, or in some implementations, the memory controller 718 may be an internal part of the processor 704.

Depending on the desired configuration, the system memory 706 may be of any type including but not limited to volatile memory (such as RAM), non-volatile memory (such as ROM, flash memory, etc.), or any combination thereof. The system memory 706 may include an operating system 720, a communication service 722, and a program data 724. The communication service 722 may include components such as a detection module. The detection module 726 may execute the processes associated with the communication service 722. The detection module 726 may analyze at least a portion of a conversation. An activity associated with the conversation may be inferred from the analyzed portion. Next, an item associated with the activity may be created. A creation notification associated with the item may be inserted into the conversation. Alternatively, a participant of the conversation may be prompted to confirm the activity. The item may be created upon receiving a confirmation.

Input to and output out of the communication service 722 may be transmitted through a communication device 766 that may be communicatively coupled to the computing device 700. The communication device 766 may provide wired and/or wireless communication. The program data 724 may also include, among other data, activity data 728, or the like, as described herein. The activity data 728 may include information associated with an item such as a task, an appointment, a meeting, a call, and/or a conference, among others.

The computing device 700 may have additional features or functionality, and additional interfaces to facilitate communications between the basic configuration 702 and any desired devices and interfaces. For example, a bus/interface controller 730 may be used to facilitate communications between the basic configuration 702 and one more data storage devices 732 via a storage interface bus 734. The data storage devices 732 may be one or more removable storage devices 736, one or more non-removable storage devices 738, or a combination thereof. Examples of the removable storage and the non-removable storage devices may include magnetic disk devices, such as flexible disk drives and hard-disk drives (HDDs), optical disk drives such as compact disk (CD) drives or digital versatile disk (DVD) drives, solid state drives (SSDs), and tape drives, to name a few. Example computer storage media may include volatile and nonvolatile, removable, and non-removable media implemented in any method or technology for storage of information, such as computer-readable instructions, data structures, program modules, or other data.

The system memory 706, the removable storage devices 736 and the non-removable storage devices 738 are examples of computer storage media. Computer storage media includes, but is not limited to, RAM, ROM, EEPROM, flash memory or other memory technology, CD-ROM, digital versatile disks (DVDs), solid state drives, or other optical storage, magnetic cassettes, magnetic tape, magnetic disk storm or other magnetic storage devices, or any other medium which may be used to store the desired information and which may be accessed by the computing device 700. Any such computer storage media may be part of the computing device 700.

The computing device 700 may also include an interface bus 740 for facilitating communication from various interface devices (for example, one or more output devices 742, one or more peripheral interfaces 744, and one or more communication devices 766) to the basic configuration 702 via the bus/interface controller 730. Some of the example output devices 742 include a graphics processing unit 748 and an audio processing unit 750, which may be configured to communicate to various external devices such as a display or speakers via one or more A/V ports 752. One or more example peripheral interfaces 744 may include a serial interface controller 754 or a parallel interface controller 756, which may be configured to communicate with external devices such as input devices (for example, keyboard, mouse, pen, voice input device, touch input device, etc.) or other peripheral devices (for example, printer, scanner, etc.) via one or more I/O ports 758. An example of the communication device(s) 766 includes a network controller 760, which may be arranged to facilitate communications with one or more other computing devices 762 over a network communication link via one or more communication ports 764. The one or more other computing devices 762 may include servers, computing devices, and comparable devices.

The network communication link may be one example of a communication media. Communication media may typically be embodied by computer readable instructions, data structures, program modules, or other data in a modulated data signal, such as a carrier wave or other transport mechanism, and may include any information delivery media. A “modulated data signal” may be a signal that has one or more of its characteristics set or changed in such a manner as to encode information in the signal. By way of example, and not limitation, communication media may include wired media such as a wired network or direct-wired connection, and wireless media such as acoustic, radio frequency (RF), microwave, infrared (IR) and other wireless media. The term computer readable media as used herein may include both storage media and communication media.

The computing device 700 may be implemented as a part of a specialized server, mainframe, or similar computer, which includes any of the above functions. The computing device 700 may also be implemented as a personal computer including both laptop computer and non-laptop computer configurations. Additionally, the computing device 700 may include specialized hardware such as an application-specific integrated circuit (ASIC), a field programmable gate array (FPGA), a programmable logic device (PLD), and/or a free form logic on an integrated circuit (IC), among others.

Example embodiments may also include methods to provide an event based activity service for a conversational environment. These methods can be implemented in any number of ways, including the structures described herein. One such way may be by machine operations, of devices of the type described in the present disclosure. Another optional way may be for one or more of the individual operations of the methods to be performed in conjunction with one or more human operators performing some of the operations while other operations may be performed by machines. These human operators need not be collocated with each other, but each can be only with a machine that performs a portion of the program. In other embodiments, the human interaction can be automated such as by pre-selected criteria that may be machine automated.

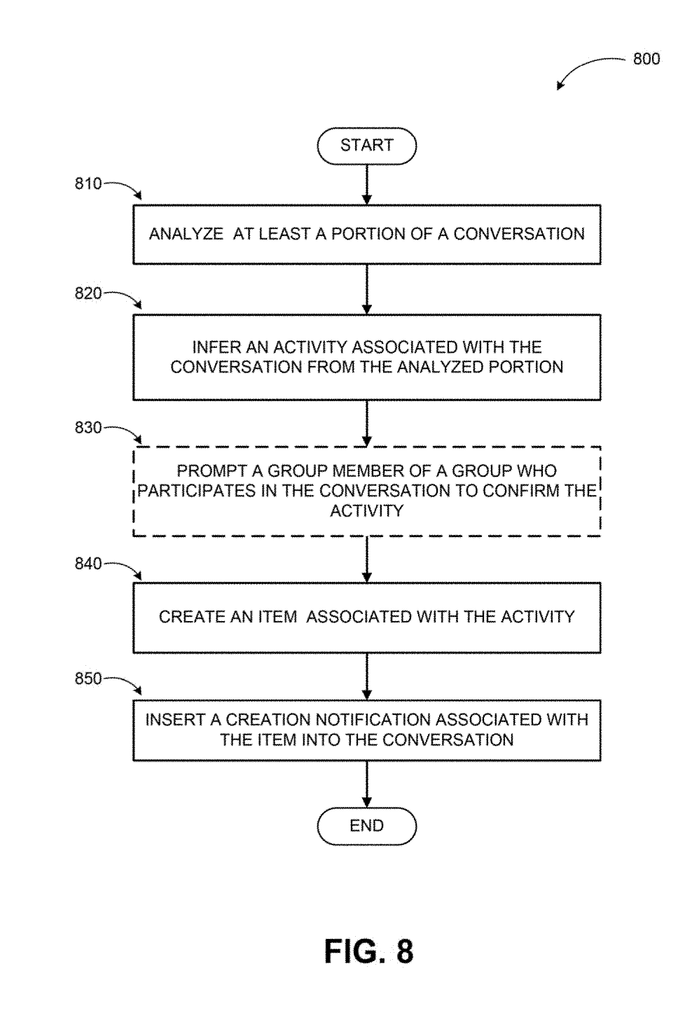

FIG. 8 is a logic flow diagram illustrating a process for providing an event based activity service for a conversational environment, according to embodiments. Process 800 may be implemented on a computing device, such as the computing device 700 or another system.

Process 800 begins with operation 810, where a communication service may analyze at least a portion of a conversation. The conversation may include a combination of text, voice, gesture, and/or visual based messages. At operation 820, an activity associated with the conversation may be inferred from the analyzed portion. The activity may include a description of an item such as a task, an appointment, a meeting, a call, and/or a conference, among others.

Next, at an optional operation 830, a group member of a group who participants in the conversation may be prompted to confirm the activity. The group member may interact and/or collaborate through the conversation. At operation 840, an item associated with the activity may be created (alternatively upon receiving a confirmation from the group member). The item may also be provided to an asset of an owner of the activity such as a scheduling service for hosting and/or management. At operation 850, a creation notification associated with the item may be inserted into the conversation. A client application rendering the conversation may display the creation notification to alert the group member (and other participant(s)) regarding the item.

The operations included in process 800 is for illustration purposes. Providing an event based activity service for a conversational environment may be implemented by similar processes with fewer or additional steps, as well as in different order of operations using the principles described herein. The operations described herein may be executed by one or more processors operated on one or more computing devices, one or more processor cores, specialized processing devices, and/or special purpose processors, among other examples.

According to some examples, a method to provide an event based activity service for a conversational environment is described. The method includes analyzing at least a portion of a conversation, inferring an activity associated with the conversation from the analyzed portion, creating an item associated with the activity, and inserting a creation notification associated with the item into the conversation.

According to other examples, the conversation includes a combination of text based messages or emails. The method further includes identifying an owner and one or more of a title and a description of a task based on the activity, generating the task as the item, and inserting the task into a calendar of the owner. The method further includes identifying an owner and one or more of a subject and a description of an appointment based on the activity, generating the appointment as the item, and inserting the appointment into a calendar of the owner. The method further includes identifying one or more invitees and one or more of a subject and a description of a meeting based on the activity, generating the meeting as the item, and inserting the meeting into one or more calendars of the one or more invitees. The meeting includes a conference call.

According to further examples, the method further includes identifying an owner of the item based on the activity, wherein the owner includes one or more of a group member of a group that is collaborating through the conversation, a group owner of the group, and an external entity that interacts with the group. The method further includes detecting the group owner as the owner of the item, identifying an association with the group owner and a second group, and associating the item with the second group based on a context of the activity or a relationship of the group owner with the second group.

According to other examples, the method further includes tracking a status of the item, detecting a change to the status of the item, and inserting a change notification associated with the status of the item into the conversation. The method further includes detecting a completion event associated with the item and inserting a completion notification associated with the item into the conversation. The method further includes receiving a request to duplicate the item, creating a duplicate of the item, and inserting a second creation notification associated with the duplicate of the item.

According to some examples, a server configured to provide an event based activity service for a conversational environment is described. The server includes a communication device configured to facilitate communication between a communication service and one or more client devices, a memory configured to store instructions, and a processor coupled to the memory and the communication device. The processor executes the communication service in conjunction with the instructions stored in the memory. The communication service includes a detection module. The detection module is configured to analyze a content of a conversation based on one or more of a text based analysis, a voice based analysis, and a gesture based analysis, infer an activity associated with the conversation from the analyzed content, prompt a group member of a group that participates in the conversation to confirm the activity, upon receiving a confirmation, create an item associated with the activity, and insert a creation notification associated with the item into the conversation.

According to other examples, the detection module is further configured to detect an identifier of a stakeholder associated with the item within the activity and assign the stakeholder as an owner of the item. The detection module is further configured to detect an association between the identifier of the stakeholder and the group member and designate the group member as the owner of the item. The detection module is further configured to detect an association between the identifier of the stakeholder and an external entity, validate an ownership authorization of the external entity to inherit the item, and upon a validation of the ownership authorization, designate the external entity as the owner of the item.

According to further examples, the detection module is further configured to detect a time period associated with the item within the activity and configure the item based on the time period. The detection module is further configured to insert a reminder notification associated with the item into the conversation prior to a start time of the time period associated with the item. The detection module is further configured to detect an association between the item and a third party provider within the activity and transmit the item to the third party provider with an instruction to host and manage the item.

According to some examples, a computer-readable memory device with instructions stored thereon to provide an event based activity service for a conversational environment is described. The instructions includes actions that are similar to the actions provided the communication service provided by the server.

According to other examples, the instructions further include detecting an identifier of the group member as associated with the item within the activity and assigning the group member as an owner of the activity.

According to some examples a means for providing an event based activity service for a conversational environment is described. The means for providing an event based activity service for a conversational environment includes a means for analyzing at least a portion of a conversation, a means for inferring an activity associated with the conversation from the analyzed portion, a means for creating an item associated with the activity, and a means for inserting a creation notification associated with the item into the conversation.

The above specification, examples and data provide a complete description of the manufacture and use the composition of the embodiments. Although the subject matter has been described in language specific to structural features and/or methodological acts, it is to be understood that the subject matter defined in the appended claims is not necessarily limited to the specific features or acts described above. Rather, the specific features and acts described above are disclosed as example forms of implementing the claims and embodiments.

What is claimed is:

1. A method to provide an event based activity service for a conversational environment, the method comprising:
analyzing at least a portion of a conversation;
inferring an activity associated with the conversation from the analyzed portion;
creating an item associated with the activity; and
inserting a creation notification associated with the item into the conversation.

2. The method of claim 1, wherein the conversation includes a combination of text based messages or emails.

3. The method of claim 1, further comprising:
identifying an owner and one or more of a title and a description of a task based on the activity;
generating the task as the item; and
inserting the task into a calendar of the owner.

4. The method of claim 1, further comprising:
identifying an owner and one or more of a subject and a description of an appointment based on the activity;
generating the appointment as the item; and
inserting the appointment into a calendar of the owner.

5. The method of claim 1, further comprising:
identifying one or more invitees and one or more of a subject and a description of a meeting based on the activity;
generating the meeting as the item; and
inserting the meeting into one or more calendars of the one or more invitees.

6. The method of claim 5, wherein the meeting includes a conference call.

7. The method of claim 1, further comprising:
identifying an owner of the item based on the activity, wherein the owner includes one or more of a group member of a group that is collaborating through the conversation, a group owner of the group, and an external entity that interacts with the group.

8. The method of claim 7, further comprising;
detecting the group owner as the owner of the item;
identifying an association with the group owner and a second group; and
associating the item with the second group based on a context of the activity or a relationship of the group owner with the second group.

9. The method of claim 1, further comprising:
tracking a status of the item;
detecting a change to the status of the item; and
inserting a change notification associated with the status of the item into the conversation.

10. The method of claim 1, further comprising;
detecting a completion event associated with the item; and
inserting a completion notification associated with the item into the conversation.

11. The method of claim 1 further comprising:
receiving a request to duplicate the item;
creating a duplicate of the item; and
inserting a second creation notification associated with the duplicate of the item.

12. A server configured to provide an event based activity service for a conversational environment, the server comprising:
a communication device configured to facilitate communication between a communication service and one or more client devices;
a memory configured to store instructions; and
a processor coupled to the memory and the communication device, the processor executing the communication service in conjunction with the instructions stored in the memory, wherein the communication service includes:
a detection module configured to:
analyze a content of a conversation based on one or more of a text based analysis, a voice based analysis, and a gesture based analysis;
infer an activity associated with the conversation from the analyzed content;
prompt a group member of a group who participates in the conversation to confirm the activity;
upon receiving a confirmation, create an item associated with the activity; and
insert a creation notification associated with the item into the conversation.

13. The server of claim 12, wherein the detection module is further configured to:
detect an identifier of a stakeholder associated with the item within the activity; and
assign the stakeholder as an owner of the item.

14. The server of claim 13, wherein the detection module is further configured to:
detect an association between the identifier of the stakeholder and the group member; and
designate the group member as the owner of the item.

15. The server of claim 13, wherein the detection module is further configured to:
detect an association between the identifier of the stakeholder and an external entity;
validate an ownership authorization of the external entity to inherit the item; and
upon a validation of the ownership authorization, designate the external entity as the owner of the item.

16. The server of claim 12, wherein the detection module is further configured to:
detect a time period associated, with the item within the activity; and
configure the item based on the time period.

17. The server of claim 16, wherein the detection module is further configured to:
insert a reminder notification associated with the item into the conversation prior to a start time of the time period associated with the item.

18. The server of claim 12, wherein the detection module is further configured to:
detect an association between the item and a third party provider within the activity; and
transmit the item to the third party provider with an instruction to host and manage the item.

19. A computer-readable memory device with instructions stored thereon to provide an event based activity service for a conversational environment, the instructions comprising:
analyzing a content of a conversation based on one or more of a text based analysis, a voice based analysis, and a gesture;
inferring an activity associated with the conversation from the analyzed content;
prompting a group member of a group who participates in the conversation to confirm the activity;
upon receiving a confirmation, creating an item associated with the activity; and
inserting a creation notification associated with the item into the conversation.

20. The computer-readable memory device of claim 19, wherein the instructions further comprise:
detecting an identifier of the group member as associated with the item within the activity; and
assigning the group member as an owner of the activity.
